(19) United States
(12) Patent Application Publication
(10) Pub. No.: US 2011/0093567 A1
(43) Pub. Date: Apr. 21, 2011

(54) MOBILE TERMINAL FOR PROVIDING MOBILE CLOUD SERVICE AND OPERATION METHOD THEREOF

(75) Inventors: Jong Hong JEON, Daejeon (KR); Seung Yun Lee, Daejeon (KR); Sung Han Kim, Daejeon (KR); Min Kyo In, Daejeon (KR); Kang Chan Lee, Daejeon (KR); Won Suk Lee, Daejeon (KR)

(73) Assignee: Electronics and Telecommunications Research Institute, Daejeon (KR)

(21) Appl. No.: 12/903,638

(22) Filed: Oct. 13, 2010

(30) Foreign Application Priority Data
Oct. 15, 2009 (KR) 10-2009-0098312

(51) Int. Cl. G06F 15/16

(52) U.S. Cl. 709/219

(57) ABSTRACT

A mobile terminal for using a mobile cloud service and an operation method of the mobile terminal are disclosed. The mobile terminal accessible to a mobile cloud server, including: a mobile cloud terminal platform accessing the mobile cloud server to acquire a cloud application, and providing a mobile cloud service by using the acquired cloud application; a local terminal platform executing a local application installed in the mobile terminal; and an operating system (OS) selectively driving one of the mobile cloud terminal platforms and the local platform according to a user set environment.

### CROSS-REFERENCE TO RELATED APPLICATIONS

This application claims the priority of Korean Patent Application No. 10-2009-0098312 filed on Oct. 15, 2009, in the Korean Intellectual Property Office, the disclosure of which is incorporated herein by reference.

### BACKGROUND OF THE INVENTION

1. Field of the Invention

The present invention relates to a cloud service technique and, more particularly, to a mobile terminal for providing a mobile cloud service in a mobile environment and an operation method thereof.

2. Description of the Related Art

The concept that computing will become a public utility such as electricity or tap water, in that it will be commonly utilized by the general public, was forecast by some experts in the early stages of the development of the Internet, and recently, computing has become generalized in this manner with the advent of cloud computing.

Cloud computing refers to an application of the mixture of various computing contents and a communication technique, such as virtualization computing, utility computing, on-demand computing, and the like. In general, cloud computing is a technique of integrating a plurality of data centers, including a plurality of computers, into a virtualization technology to implement a single virtual computer or service which provides various software items, a security solution, computing capability, and the like, on-demand, to users who are connected thereto.

Namely, cloud computing is ‘an Internet-based IT resource on-demand outsourcing service’, whereby programs or documents, which are individually stored in a personal computer or a company server, can be stored in an Internet-based virtual server or storage, and a cloud application such as a Web browser or the like is driven by using various terminals such as the personal computer or the like, to allow users to perform a desired operation.

In this case, users may choose to use computing resources such as the cloud application, data storage, an operating system (OS), a security solution, and the like, as much as they want, at a desired point in time and make a payment based on the usage amount.

With cloud computing yet to be full-fledged, major companies including Google, Microsoft, IBM, or the like, are actively conducting research into a cloud computing service, a service platform technology, a virtualization technology, and the like.

The development of such a cloud computing technique is mostly focused on the desk top-centered computing environment or on virtualization technology, in the aspect of a server aimed at having a large processing capacity effectively processing large amounts of data, without consideration of a service technique with respect to a mobile environment based on various small terminals.

In actuality, however, in the recent communications environment, in which a diverse array of mobile terminals such as mobile phones, smartphones, notebook computers, navigation devices, portable multimedia players (PMPs), and the like, are in use, user demand for effectively accessing a cloud application and service, regardless of a place, a terminal type, and a network, etc., is increasing.

Of course, the growth of a Web-based cloud application technique has led to the spread of Web-based cloud services allowing for the use of cloud applications such as a Web office, or Web mail, at any time, by using a Web browser supporting a standard technology, and presently, a smartphone such as an iPhone is able to utilize such an environment. However, an effective cloud service interworking method with respect to individual cloud applications providing complicated interfaces and functions has not yet been proposed.

### SUMMARY OF THE INVENTION

An aspect of the present invention provides a mobile terminal capable of providing a cloud service in a mobile environment and an operation method thereof.

Another aspect of the present invention provides a method for easily solving a problem with an installation of a cloud application and synchronization with respect to various types of mobile terminals and allowing the mobile terminals, each including a mobile cloud terminal platform, to utilize the same cloud application, and an operation method of a mobile terminal.

Still another aspect of the present invention provides a mobile terminal capable of providing a mobile cloud service association function by simply using only a platform function without consideration of a cloud computing function.

According to an aspect of the present invention, there is provided a mobile terminal accessible to a mobile cloud server, including: a mobile cloud terminal platform accessing the mobile cloud server to acquire a cloud application, and providing a mobile cloud service by using the acquired cloud application; a local terminal platform executing a local application installed in the mobile terminal; and an operating system (OS) selectively driving one of the mobile cloud terminal platform and the local platform according to a user set environment.

When a connection to the mobile cloud server is not available, the mobile cloud terminal platform may have a function of providing a limited mobile cloud service by using information which has been cashed when the mobile cloud service was previously provided.

The mobile cloud terminal platform may repeatedly perform synchronization with the mobile cloud server in the middle of providing the mobile cloud service.

The mobile cloud terminal platform may include: a cashing and synchronization unit cashing a cloud application executed when the mobile cloud service is provided and performing synchronization between the mobile terminal and the mobile cloud server; a memory management unit storing and managing a cloud application transmitted from the mobile cloud server; a network connection unit performing a connection to the mobile cloud server and maintaining and managing a channel established between the mobile terminal and the mobile cloud server; an OS interworking unit determining whether to drive the mobile cloud terminal platform by interworking with the OS; and a cloud service interworking unit providing a mobile cloud service by using information stored in the memory management unit when a connection to the mobile cloud server is available, and providing a limited mobile cloud service by using the information stored in the cashing and synchronization unit when a connection to the mobile cloud server is not available.

The mobile cloud terminal platform may include: a terminal API providing unit performing a cooperative operation with a different mobile terminal; a security and authentication information management unit storing and managing security and authentication information for determining whether to permit the cooperative operation; a file and storage management unit managing key data, related to the mobile cloud service, in the form of a file; and an application management unit installing and executing a cloud application for providing a mobile cloud service.

According to another aspect of the present invention, there is provided a system for providing a mobile cloud service, including: a mobile cloud server storing and providing a cloud application for providing a mobile cloud service; and one or more mobile terminals, each including, a mobile cloud terminal platform, receiving a cloud application from the mobile cloud server through the mobile cloud terminal platform and providing a mobile cloud service.

When a connection of a mobile terminal is detected, the mobile cloud server may acquire detailed terminal information of the mobile terminal through a terminal information server to recognize a mobile cloud service for the mobile terminal, and provide a cloud application according to the recognized mobile cloud service.

The mobile terminal may include: a mobile cloud terminal platform accessing the mobile cloud server to receive the cloud application and providing the mobile cloud service by using the received cloud application; a local terminal platform executing the local application installed in the mobile terminal; and an operating system (OS) selectively driving one of the mobile cloud terminal platform and the local platform according to a user set environment.

When a connection to the mobile cloud server is not available, the mobile cloud terminal platform may have a function of providing a limited mobile cloud service by using information which has been cashed when the mobile cloud service was previously provided.

The mobile cloud terminal platform may repeatedly perform synchronization with the mobile cloud server in the middle of providing the mobile cloud service.

According to another aspect of the present invention, there is provided a method for operating a mobile terminal equipped with a mobile cloud terminal platform, including: checking whether or not a driving mode of the mobile terminal is a mobile cloud service mode; when the driving mode of the mobile terminal is the mobile cloud service mode, checking whether or not a connection to a mobile cloud server is available; when a connection to the mobile cloud server is available, driving the mobile cloud terminal platform to receive a cloud application from the mobile cloud server and provide a mobile cloud service; and when a connection to the mobile cloud server is not available, providing a limited mobile cloud service by using cashing information which has been cashed when the mobile cloud service was previously provided.

The method may further include: when the driving mode of the mobile terminal is not the cloud service mode, executing a local application installed in the mobile terminal.

The providing of the mobile cloud service may include: when the mobile cloud terminal platform is initialized, performing a connection to the mobile cloud service; requesting synchronization from the mobile cloud server to receive a cloud application of the latest version; and driving the mobile cloud terminal platform according to the received cloud application.

The providing of the mobile cloud service may include: synchronizing the cashing information with the mobile cloud server according to the received cloud application.

The providing of the mobile cloud service may include: repeatedly performing synchronization with the mobile cloud server periodically or asynchronously when the mobile cloud terminal platform is in a driven state.

The method may further include: when a service API or a data API provided in the mobile cloud terminal platform is called by a different mobile terminal, performing a cooperative operation with the different mobile terminal through the service API or the data API.

The performing of the cooperative operation may include: when the service API provided in the mobile cloud terminal platform is called by the different mobile terminal, processing a service through the service API; and providing the results obtained by processing the service to the different mobile terminal.

The performing of the cooperative operation may include: when the data API provided in the mobile cloud terminal platform is called by the different mobile terminal, transmitting and receiving data to and from the different mobile terminal through the data API.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 illustrates the configuration of a system for providing a mobile cloud service according to an exemplary embodiment of the present invention;

FIG. 2 is a schematic block diagram showing an internal configuration of a mobile terminal according to an exemplary embodiment of the present invention;

FIG. 3 is a detailed block diagram of a mobile cloud terminal platform according to an exemplary embodiment of the present invention;

FIG. 4 is a flow chart illustrating the process of an operation method of the system for providing a mobile cloud service according to an exemplary embodiment of the present invention;

FIG. 5 is a flow chart illustrating the process of selecting and driving a platform of a mobile terminal according to an exemplary embodiment of the present invention;

FIG. 6 is a flow chart illustrating the process of driving the mobile cloud terminal platform according to an exemplary embodiment of the present invention; and

FIG. 7 is a flow chart illustrating the process of a cooperative operation method between mobile terminals using the mobile cloud terminal platform according to an exemplary embodiment of the present invention.

### DETAILED DESCRIPTION OF THE PREFERRED EMBODIMENT

Exemplary embodiments of the present invention will now be described in detail with reference to the accompanying drawings. The invention may, however, be embodied in many different forms and should not be construed as being limited to the embodiments set forth herein. Rather, these embodiments are provided so that this disclosure will be thorough and complete, and will fully convey the scope of the invention to those skilled in the art. In the drawings, the shapes and dimensions may be exaggerated for clarity, and the same reference numerals will be used throughout to designate the same or like components.

A mobile terminal and an operation method thereof according to exemplary embodiments of the present invention allow for a convenient use of a cloud application in association with a mobile cloud service in various terminal environments such as desktop computers and small devices, as well as mobile devices including a mobile phone, a smartphone, a notebook computer, a navigation device, a portable multimedia player (PMP), and the like.

For example, ‘zoho.com’ provides an online service with respect to document storage and retrieval, e-mail, report creation, schedule management, and the like, ‘Salesforce.com,’ providing a client management service, ‘Microsoft,’ providing a software as a service (Saas), and ‘Amazon,’ an online bookstore, providing a Web service, and the like, are typical businesses providing a mobile cloud service.

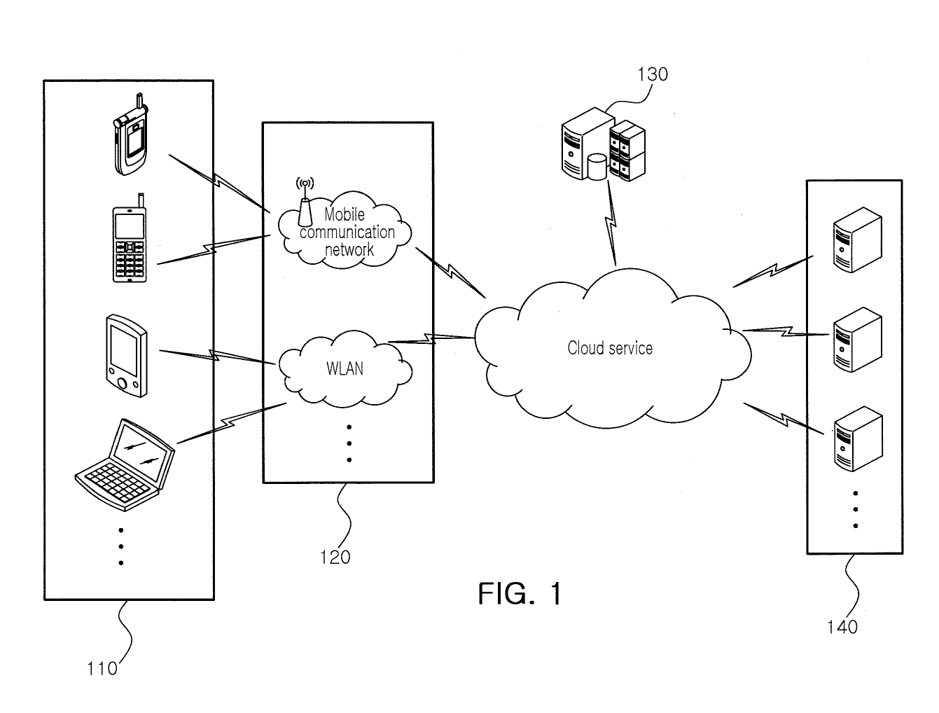

FIG. 1 illustrates the configuration of a system for providing a mobile cloud service according to an exemplary embodiment of the present invention.

With reference to FIG. 1, the system for providing a mobile cloud service according to an exemplary embodiment of the present invention includes a mobile terminal 110, a wireless communication network 120, a terminal information server 130, a mobile cloud server 140, etc.

The mobile terminal 110 includes a mobile cloud terminal platform through which the mobile terminal 100 is connected to the mobile cloud server 140 to receive an application required for providing a mobile cloud server, a storage, an operating system (OS), a security function, and the like (which will be generally referred to as a ‘cloud application’ hereinafter for the sake of brevity).

Here, the mobile terminal 110 may include any type of electronic device, such as a mobile phone, a smartphone, a notebook computer, a navigation device, a PMP, and the like, that can perform data communication via the wireless communication network 120.

The wireless communication network 120 may be a wireless LAN, a mobile communication network, and the like, and provide a pertinent network environment according to the type of the mobile terminal 110.

The terminal information server 130 stores and manages terminal information regarding a plurality of mobile terminals. In response to a request from the mobile cloud server 140, the terminal information server 130 acquires detailed terminal information of a corresponding mobile terminal and provides the same to the mobile cloud server 140.

The mobile cloud server 140 may be a server cluster and a plurality of virtualization servers. When the mobile cloud server detects a connection of the mobile terminal 110 that intends to provide a mobile cloud service to a user, the mobile cloud server 140 acquires detailed terminal information regarding the corresponding mobile terminal 110 via the terminal information server 130 and recognizes a service providing method and an interface method suitable for the corresponding mobile terminal 110. The mobile cloud server 140 then provides a mobile cloud service appropriate for the mobile terminal with reference to the recognized service providing method and interface method.

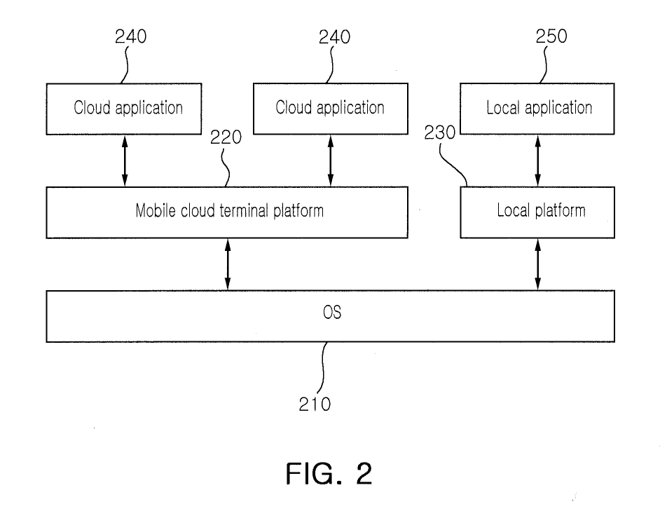

FIG. 2 is a schematic block diagram showing an internal configuration of a mobile terminal according to an exemplary embodiment of the present invention.

With reference to FIG. 2, the mobile terminal 110 according to an exemplary embodiment of the present invention includes an operating system (OS) 210, a mobile cloud terminal platform 220, a local platform 230, at least one cloud application 240 and at least one local application 250.

The OS 210 initializes basic elements of the mobile terminal 110 and establishes an operational environment for the mobile terminal 110, and then selectively drives one of the mobile cloud terminal platform 220 and the local platform 230 according to a user set environment.

In this case, the OS 210 operates as follows: When a connection to the mobile cloud server 140 is not available, even in the case that the mobile cloud terminal platform 220 has been selected, the OS limitedly drives the mobile cloud terminal platform 220 by using information which was cached in the mobile cloud terminal platform 220 when a mobile cloud service was previously provided, and then, when a connection to the mobile cloud server 140 is available, the OS 210 drives the mobile cloud terminal platform 220 a hundred percent. This is to minimize an influence caused by a network failure.

The mobile cloud terminal platform 220 receives a cloud application from the mobile cloud server 140 and provides a mobile cloud service. Also, when a connection to the mobile cloud server 140 is not available, the mobile cloud terminal platform 220 provides a limited mobile cloud service by using the information which was cached when the mobile cloud was previously provided.

The local platform 230 executes the local application 250 or a service basically installed in the mobile terminal 110, and provides it to the user.

The cloud application 240 includes various cloud applications that can be driven by the mobile cloud terminal platform 220, and the local application 250 includes various cloud applications that can be driven by the local platform 230.

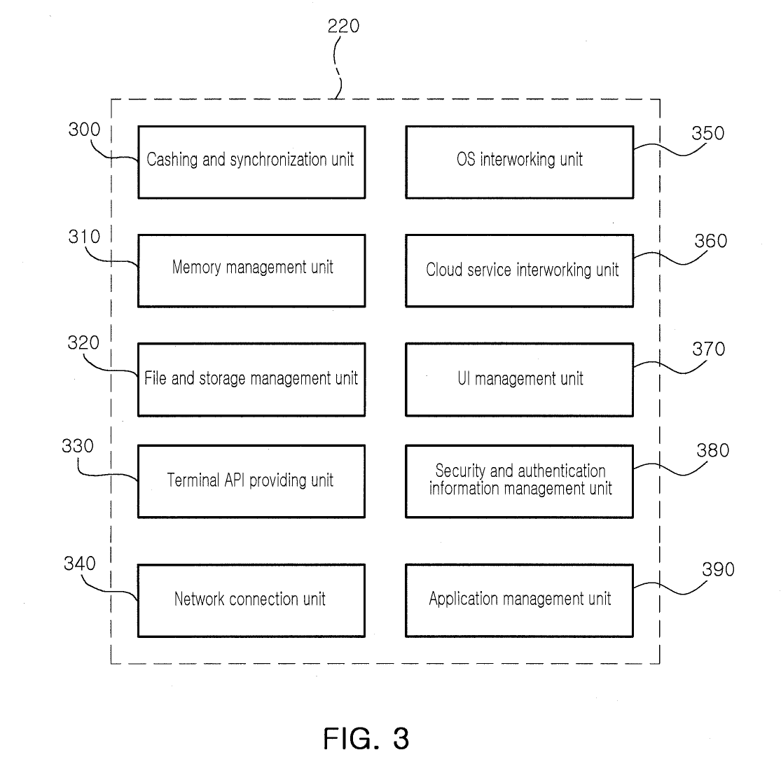

FIG. 3 is a detailed block diagram of the mobile cloud terminal platform according to an exemplary embodiment of the present invention.

With reference to FIG. 3, the mobile cloud terminal platform 220 includes a caching and synchronization unit 300, a memory management unit 310, a file and storage management unit 320, a terminal application programming interface (API) providing unit 330, a network connection unit 340, an OS interworking unit 350, a cloud service interworking unit 360, a user interface (UI) management unit 370, a security and authentication information management unit 380, an application management unit 390, and the like.

The caching and synchronization unit 300 caches a cloud application executed when the mobile terminal 110 provides a mobile cloud service. Also, the caching and synchronization unit 300 repeatedly performs synchronization between the mobile terminal 110 and the mobile cloud server 140 periodically or asynchronously in order to allow for the provision of the mobile cloud service, always including the latest information.

The memory management unit 310 stores and manages the cloud application transmitted from the mobile cloud server 140.

The file and storage management unit 320 manages key data related to the mobile cloud service, in the form of a file.

The terminal API providing unit 330, including a data API and a service API, calls an open interface and a Web service scheme through the data API and the service API and performs a cooperative operation with a different mobile terminal. In this case, data transmitted and received for the cooperative operation uses a data format of XML, RSS, or the like.

The network connection unit 340 performs a connection to a wireless communication network implemented as a mobile communication network, a WLAN, and the like, and a connection to a Web service. In particular, the network connection unit 340 performs a connection to a mobile cloud server 140, and maintains and manages a channel established between the mobile terminal 110 and the mobile cloud server 140 to provide a mobile cloud service.

The OS interworking unit 350 interworks with the OS 210 of the mobile terminal 110 to determine whether to drive the mobile cloud terminal platform 220.

When the mobile cloud terminal platform 220 is driven, the cloud service interworking unit 360 checks whether a connection to the mobile cloud server 140 through the network connection unit 340 is available. When a connection to the mobile cloud server 140 is available, the cloud service interworking unit 360 provides a mobile cloud service according to information stored in the memory management unit 310. Meanwhile, when the connection to the mobile cloud server 140 is not available, the cloud service interworking unit 360 provides a mobile cloud service according to the cached information stored in the caching and synchronization unit 300. Namely, the cloud service interworking unit 360 selects the type of information to be used according to whether or not the connection to the mobile cloud server 140 is available, and provides a mobile cloud service to the user in association with a virtual memory, a virtual CPU, an API, a Web service, and the like, of the mobile cloud service based on the selected information.

The user interface management unit 370 serves to detect and acquire various user inputs for controlling the operation of the mobile cloud terminal platform 220. The user interface management unit 370 may be implemented as various types of input units including a keypad, a touch pad, a keyboard, a mouse, and the like.

The security and authentication information management unit 380 stores and manages security and authentication information for determining whether to permit a cooperative operation of the terminal API providing unit 330. The application management unit 390 manages an installation and execution of a cloud application for providing a mobile cloud service.

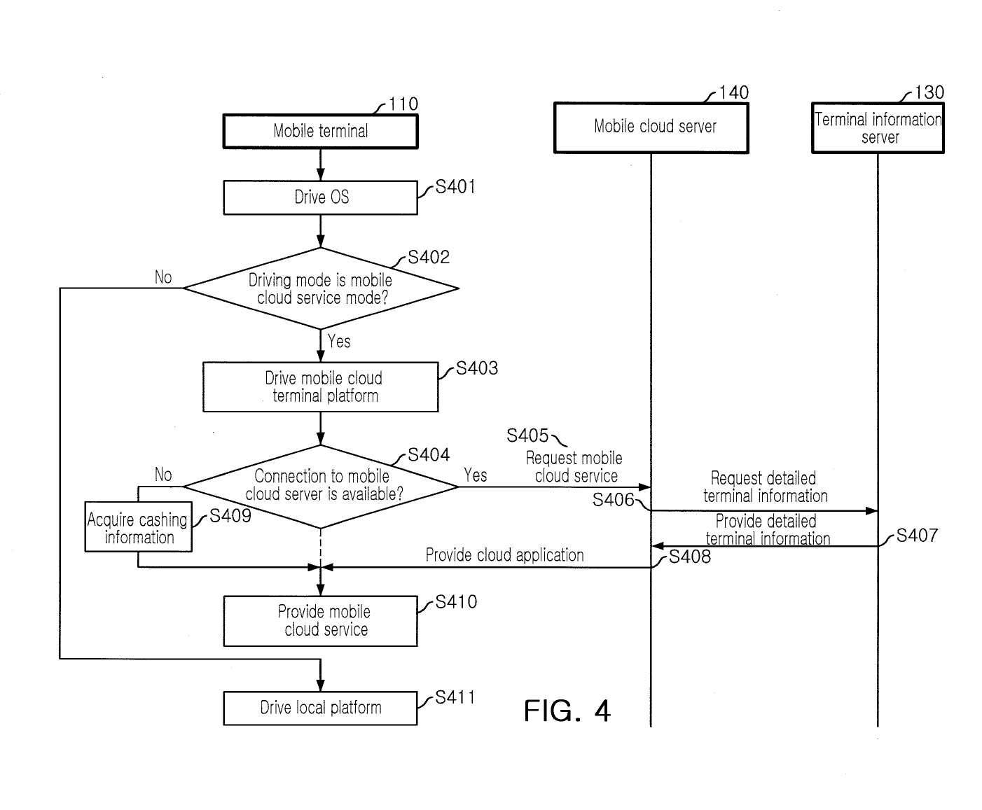

FIG. 4 is a flow chart illustrating the process of an operation method of the system for providing a mobile cloud service according to an exemplary embodiment of the present invention.

First, when the power of the mobile terminal 110 is turned on, the mobile terminal 110 checks basic hardware, performs a testing operation, and then drives the OS 210 (S401).

The OS 210 establishes a hardware and software execution environment, checks whether or not a driving mode of the mobile terminal 110 is a mobile cloud service mode (S402), and then selectively drives the mobile cloud terminal platform 220 (S403).

When a connection to the mobile cloud server 140 is available (S404), the mobile cloud terminal platform 220 provides terminal information, a usage environment, and basic information required for a cooperative operation between servers to the mobile cloud server 140 in order to request a mobile cloud service from the mobile cloud server 140 (S405).

The mobile cloud server 140 acquires detailed terminal information corresponding to terminal identification information which has been received through the terminal information server 130 (S406 and S407), recognizes a mobile cloud service fitting a driving environment of the mobile terminal 110, and provides a corresponding cloud application to the mobile terminal 110 (S408).

The mobile terminal 110 receives the cloud application and provides a mobile cloud service to the user by using the received cloud application (S410).

Meanwhile, when a connection to the mobile cloud server 140 is not available (S404), the mobile cloud terminal platform 220 acquires information which has been cached when a mobile cloud service was provided in the past (S409), and provides a limited mobile cloud service to the user by using the acquired information (S410).

Meanwhile, when the driving mode of the mobile terminal 110 is a general service mode (S402), the OS 210 selectively drives the local platform (S411). In this case, the procedure for driving the local platform follows the related art, and a detailed description thereof will be omitted.

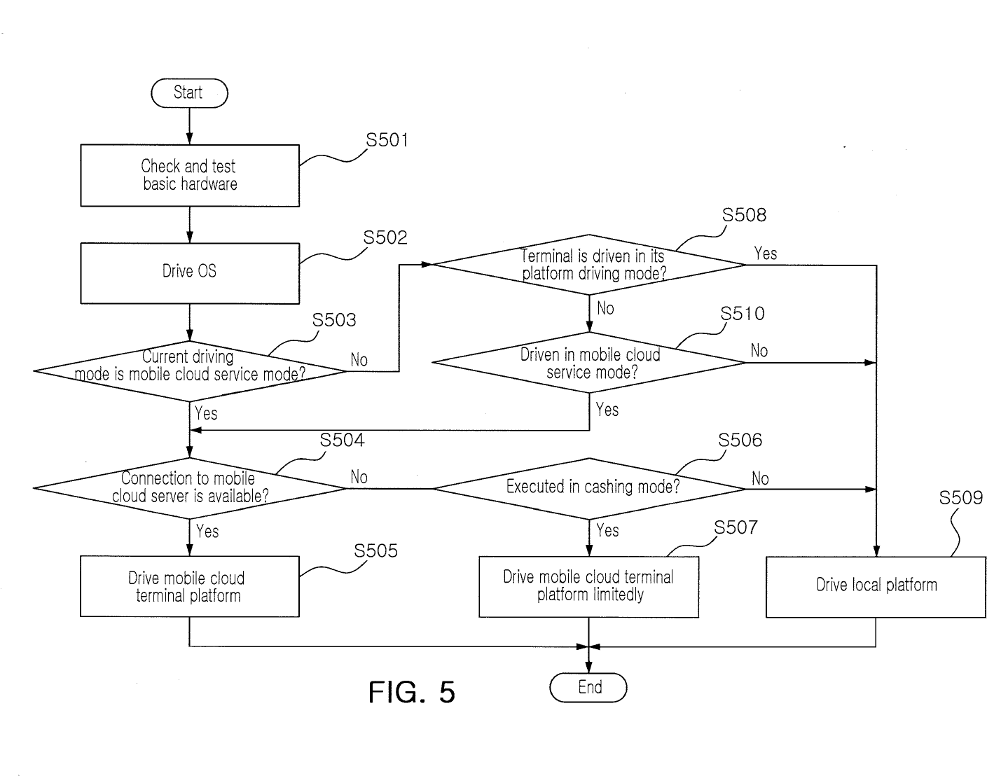

FIG. 5 is a flow chart illustrating the process of selecting and driving a platform of a mobile terminal according to an exemplary embodiment of the present invention.

When power of the mobile terminal is turned on, the mobile terminal 110 checks basic hardware and performs testing (S501), and then drives an OS installed within the terminal to establish a hardware and software execution environment (S502).

Thereafter, it is checked whether or not a driving mode of the mobile terminal 110 currently set through a user setenvironment is a mobile cloud service mode (S503).

If the driving mode of the mobile terminal 110 is set as the mobile cloud service mode, the mobile cloud terminal platform 220 checks an available network type and state to ascertain whether or not a connection to the mobile cloud server 140 is available (S504).

Upon checking in step S504, if a connection to the mobile cloud server 140 is available, the mobile cloud terminal platform is driven so as to acquire a cloud application required for the mobile cloud service through the mobile cloud server 140 and provides a mobile cloud service to the user based on the acquired cloud application (S505).

Meanwhile, if a connection to the mobile cloud server 140 is not available, according to the result of checking in step S504, the user is asked whether to execute the mobile terminal in a caching mode (S506) and the mobile cloud terminal platform is limitedly driven by using cached information of the caching and synchronization unit 300 according to a user agreement (S507).

When the driving mode of the mobile terminal 110 is set as a general service mode, rather than the mobile cloud service mode, the user is asked whether to execute the mobile terminal in the general service mode (S508), and the local platform is driven according to a user agreement (S509).

Meanwhile, if the user refuses to execute in the general service mode, the user is asked whether to execute the mobile terminal 110 in the mobile cloud service mode (S510).

When the user requests the execution of the mobile terminal in the mobile cloud service mode according to the inquiry result in step S5510, the mobile cloud terminal platform is driven in step S504, or otherwise, the local platform is driven in step S509.

In this manner, the mobile terminal 110, including the mobile cloud terminal platform, is connected to the mobile cloud server 140 through the mobile cloud terminal platform to receive a cloud application required for a mobile cloud service to thus provide a mobile cloud service in the mobile environment. When a network connection between the mobile terminal 110 and the mobile cloud server 140 is not available, the mobile cloud terminal platform is limitedly driven by using the information cached in the mobile terminal 110, to thereby continuously provide the mobile cloud service even when a network failure occurs.

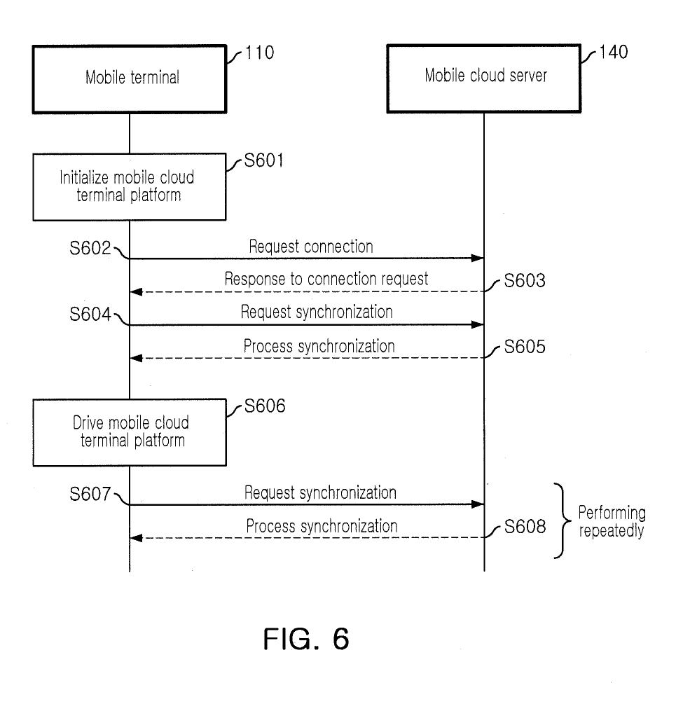

FIG. 6 is a flow chart illustrating the process of driving the mobile cloud terminal platform according to an exemplary embodiment of the present invention.

When the mobile cloud service mode is selected as shown in FIG. 5, the mobile cloud terminal platform 220 is initialized (S601) and transmits its terminal information, a usage environment, basic information required for a cooperative operation between servers, and the like, to the mobile cloud server 140 to request a connection (S602).

Then, the mobile cloud server 140 checks whether a connection of the mobile terminal 110 is available, and provides a response to the connection request to the mobile terminal 110 (S603).

If the mobile terminal server 140 accepts the connection of the mobile terminal 110, the mobile cloud terminal platform 220 gathers its alteration history based on a final connection termination time point and provides the same to the mobile cloud server 140, and requests synchronization (S604).

The mobile cloud server 140 compares the alteration history of the mobile terminal 110 and its alteration history (or update history), and if the mobile terminal 110 has information of a previous version, the mobile cloud server 140 provides a cloud application of the latest version to the mobile terminal 110. Namely, the mobile cloud server 140 processes synchronization between the mobile terminal 110 and the mobile cloud server 140 (S605). At this time, the mobile terminal 110 also synchronizes cached information in the mobile cloud terminal platform 220 according to the cloud application of the latest version.

When the basic synchronization process is completed through steps S602 to S605, the mobile terminal 110 drives the mobile cloud terminal platform 220 according to the cloud application which has been provided from the mobile cloud server 140 to provide a mobile cloud service to the user (S606).

Also, the mobile terminal 110 repeatedly requests synchronization periodically or asynchronously, receives corresponding information, and is synchronized with the mobile cloud server 140 until such time as the driving of the mobile cloud terminal platform is terminated (S607 and S608).

Accordingly, the mobile terminal 110 according to an exemplary embodiment of the present invention always receives the cloud application of the latest version from the mobile cloud server 140 and provides the mobile cloud service to the user.

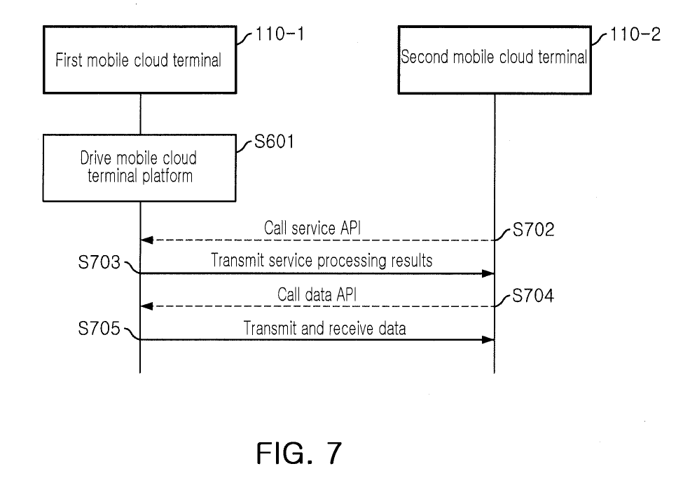

FIG. 7 is a flow chart illustrating the process of a cooperative operation method between mobile terminals using the mobile cloud terminal platform according to an exemplary embodiment of the present invention.

In FIG. 7, a mobile terminal that performs a cooperative operation will be referred to as a first mobile terminal 110-1 and a mobile terminal that requests the cooperative operation will be referred to as a second mobile terminal 110-2, for the sake of brevity.

The first and second mobile terminals 110-1 and 110-2 call the service API and the data API provided through the terminal API providing unit 330 and transmit and receive data and a service required for their mutual cooperative operation. Namely, the first and second mobile terminals 110-1 and 110-2 call an open interface and a Web service scheme provided from the terminal API providing unit 330 and transmit and receive data and a service. In this case, the mobile terminals 110-1 and 110-2 use a data format such as XML, RSS, and the like, in order to process the open API, and may provide remote interfaces of various Web service schemes.

With reference to FIG. 7, in a state that the first mobile terminal 110-1 drives the mobile cloud terminal platform 220 (S701), when the second mobile terminal 110-2 calls the service API of the first mobile terminal 110-1 (S702), the first mobile terminal 110-1 processes a service required by the second mobile terminal 110-2 and transmits the service processing result to the second mobile terminal 110-2 (S703).

Also, when the second mobile terminal 110-2 transmits a data API call request signal, including security and authentication information, to call the data API (S704), the first mobile terminal 110-1 performs the operation of data transmission and reception with the second mobile terminal 110-2 through the data API (S705).

In this case, the service API and the data API according to an exemplary embodiment of the present invention can be also used for complicated processing such as updating, correcting, deleting, and the like, of data and a service between the mobile terminals, as well as simply sharing data and services.

As set forth above, according to the mobile terminal for using a mobile cloud service and an operation method of the mobile terminal in the exemplary embodiments of the invention, a mobile cloud service can be received by using the mobile terminal equipped with the mobile terminal platform supporting a mobile cloud usage environment. Thus, a cloud application and data can be received such that it is suitable for the terminal any time and anywhere in any terminal environment, and the user can be provided with a personal platform environment and a cloud application uniformly in any place by using the mobile cloud terminal platform-equipped terminal, whereby the user can effectively receive his desired could application data any time and anywhere.

Also, the user can easily solve the problem of synchronization between the terminal and the mobile cloud server in the environment in which the user uses a plurality of mobile terminals.

In addition, the user can easily solve the problem of synchronization between a plurality of mobile terminals and the mobile cloud server in an environment in which the plurality of mobile terminal are in use.

Moreover, the same cloud application and data provided through the mobile cloud service can be utilized in various mobile terminals by using the mobile terminal including the mobile cloud terminal platform.

Furthermore, a developer can conveniently provide an association function with the mobile cloud service only with a function supported by the platform part without consideration of a cloud computing function.

Also, the problems with an installation of the cloud application in a mobile environment, maintaining data consistency, overlapping issue in using a plurality of mobile terminals, cloud application driving compatibility, and the like, can be solved.

While the present invention has been shown and described in connection with the exemplary embodiments, it will be apparent to those skilled in the art that modifications and variations can be made without departing from the spirit and scope of the invention as defined by the appended claims.

What is claimed is:

1. A mobile terminal accessible to a mobile cloud server, the mobile terminal comprising:
a mobile cloud terminal platform accessing the mobile cloud server to acquire a cloud application, and providing a mobile cloud service by using the acquired cloud application;
a local terminal platform executing a local application installed in the mobile terminal; and
an operating system (OS) selectively driving one of the mobile cloud terminal platform and the local platform according to a user set environment.

2. The mobile terminal of claim 1, wherein, when a connection to the mobile cloud server is not available, the mobile cloud terminal platform has an additional function of providing a limited mobile cloud service by using information which has been cashed when the mobile cloud service was previously provided.

3. The mobile terminal of claim 1, wherein the mobile cloud terminal platform repeatedly performs synchronization with the mobile cloud server in the middle of providing the mobile cloud service.

4. The mobile terminal of claim 1, wherein the mobile cloud terminal platform comprises:
a cashing and synchronization unit cashing a cloud application executed when the mobile cloud service is provided and performing synchronization between the mobile terminal and the mobile cloud server;
a memory management unit storing and managing a cloud application transmitted from the mobile cloud server;
a network connection unit performing a connection to the mobile cloud server and maintaining and managing a channel established between the mobile terminal and the mobile cloud server;
an OS interworking unit determining whether to drive the mobile cloud terminal platform by interworking with the OS; and
a cloud service interworking unit providing a mobile cloud service by using information stored in the memory management unit when a connection to the mobile cloud server is available, and providing a limited mobile cloud service by using the information stored in the cashing and synchronization unit when a connection to the mobile cloud server is not available.

5. The mobile terminal of claim 4, wherein the mobile cloud terminal platform further comprises:
a terminal API providing unit performing a cooperative operation with a different mobile terminal; and
a security and authentication information management unit storing and managing security and authentication information for determining whether to permit the cooperative operation.

6. The mobile terminal of claim 4, wherein the mobile cloud terminal platform further comprises:
a file and storage management unit managing key data, related to the mobile cloud service, in the form of a file.

7. The mobile terminal of claim 4, wherein the mobile cloud terminal platform further comprises:
an application management unit installing and executing a cloud application for providing a mobile cloud service.

8. A system for providing a mobile cloud service, the system comprising:
a mobile cloud server storing and providing a cloud application for providing a mobile cloud service; and
one or more mobile terminals, each including, a mobile cloud terminal platform, receiving a cloud application from the mobile cloud server through the mobile cloud terminal platform and providing a mobile cloud service.

9. The system of claim 8, wherein when a connection of a mobile terminal is detected, the mobile cloud server acquires detailed terminal information of the mobile terminal through a terminal information server to recognize a mobile cloud service for the mobile terminal, and provides a cloud application according to the recognized mobile cloud service.

10. The system of claim 9, wherein the mobile terminal comprises:
a mobile cloud terminal platform accessing the mobile cloud server to receive the cloud application and providing the mobile cloud service by using the received cloud application;
a local terminal platform executing the local application installed in the mobile terminal; and
an operating system (OS) selectively driving one of the mobile cloud terminal platform and the local platform according to a user set environment.

11. The system of claim 10, wherein when a connection to the mobile cloud server is not available, the mobile cloud terminal platform has an additional function of providing a limited mobile cloud service by using information which has been cashed when the mobile cloud service was previously provided.

12. The system of claim 10, wherein the mobile cloud terminal platform repeatedly performs synchronization with the mobile cloud server in the middle of providing the mobile cloud service.

13. A method for operating a mobile terminal equipped with a mobile cloud terminal platform, the method:
checking whether or not a driving mode of the mobile terminal is a mobile cloud service mode;
when the driving mode of the mobile terminal is the mobile cloud service mode, checking whether or not a connection to a mobile cloud server is available;
when a connection to the mobile cloud server is available, driving the mobile cloud terminal platform to receive a cloud application from the mobile cloud server and provide a mobile cloud service; and
when a connection to the mobile cloud server is not available, providing a limited mobile cloud service by using cashing information which has been cashed when the mobile cloud service was previously provided.

14. The method of claim 13, further comprising:
when the driving mode of the mobile terminal is not the cloud service mode, executing a local application installed in the mobile terminal.

15. The method of claim 13, wherein the providing of the mobile cloud service comprises:
when the mobile cloud terminal platform is initialized, performing a connection to the mobile cloud service;
requesting synchronization from the mobile cloud server to receive a cloud application of the latest version; and
driving the mobile cloud terminal platform according to the received cloud application.

16. The method of claim 13, wherein the providing of the mobile cloud service further comprises:
synchronizing the cashing information with the mobile cloud server according to the received cloud application.

17. The method of claim 15, wherein the providing of the mobile cloud service further comprises:
repeatedly performing synchronization with the mobile cloud server periodically or asynchronously when the mobile cloud terminal platform is in a driven state.

18. The method of claim 13, further comprising:
when a service API or a data API provided in the mobile cloud terminal platform is called by a different mobile terminal, performing a cooperative operation with the different mobile terminal through the service API or the data API.

19. The method of claim 18, wherein the performing of the cooperative operation comprises:
when the service API provided in the mobile cloud terminal platform is called by the different mobile terminal, processing a service through the service API; and
providing the results obtained by processing the service to the different mobile terminal.

20. The method of claim 18, wherein the performing of the cooperative operation comprises:
when the data API provided in the mobile cloud terminal platform is called by the different mobile terminal, transmitting and receiving data to and from the different mobile terminal through the data API.
